(19) United States
(12) Patent Application Publication
(10) Pub. No.: US 2013/0226888 A1
(43) Pub. Date: Aug. 29, 2013

(54) SYSTEMS AND METHODS FOR CACHING DATA FILES

(71) Applicants: Subin Govind, San Jose, CA (US); Ajeet B. Kumar, Bangalore (IN)

(72) Inventors: Subin Govind, San Jose, CA (US); Ajeet B. Kumar, Bangalore (IN)

(73) Assignee: NetApp, Inc., Sunnyvale, CA (US)

(21) Appl. No.: 13/407,496

(22) Filed: Feb. 28, 2012

(51) Int. Cl. G06F 7/00

(52) U.S. Cl. 707/698; 707/E17.01

(57) ABSTRACT

Systems and methods including storage systems that employ local file caching processes and that generate state variables to record, for subsequent use, intermediate states of a file hash process. In certain specific examples, there are systems that interrupt a hash process as it processes the data blocks of a file, and stores the current product of the interrupted hash process as a state variable that represents the hash value generated from the data blocks processed prior to the interruption. After interruption, the hash process continues processing the file data blocks. The stored state variables may be organized into a table that associates the state variables with the range of data blocks that were processed to generate the respective state variable. Such exemplary systems can be used with any type of storage system, including filers, database systems or other storage applications.

### FIELD OF THE INVENTION

The systems and methods described herein relate to systems and methods that store data on a network, and particularly, to file systems and methods that store data and employ local file caches.

### BACKGROUND

A storage system is a processing system adapted to store and retrieve information/data on storage devices, such as disks or other forms of primary storage. Typically, the storage system includes a storage operating system that implements a file system to organize information into a hierarchical structure of directories and files. Each file typically comprises a set of data blocks, and each directory may be a specially-formatted file in which information about other files and directories are stored.

The storage operating system generally refers to the computer-executable code operable on a storage system that manages data access and access requests (read or write requests requiring input/output operations) and supports file system semantics in implementations involving storage systems. The Data ONTAP® storage operating system, available from NetApp, Inc. of Sunnyvale, Calif., which implements a Write Anywhere File Layout (WAFL®) file system, is an example of such a storage operating system. The storage operating system can also be implemented as an application program operating over a general-purpose operating system, such as UNIX® or Windows®, or as a general-purpose operating system configured for storage applications.

Storage operating systems can provide for managing files and storing data across a computer network. As such, a user at one node on the network can request a file which is stored at another remote node. The storage operating system can manage the necessary protocols to retrieve the desired file from the remote location for use by a user at the local node. Although these systems can work very well, file transfer across a network can be time consuming and can result in substantial increases in network traffic. This is particularly true if there are heavily requested large data files that are consistently requested and transferred across the network. To address this issue, scientists and engineers have developed techniques for locally caching data files that are commonly requested by users, or otherwise likely to impact network bandwidth or network availability.

Caching typically involves the local node identifying a data file that should be copied and locally stored. When a user at that node requests that cached data file, rather than retrieving the original file from the remote node, the storage operating system recognizes that the file is maintained within the local cache and retrieves the file from that local cache. This eliminates, or at least reduces, the need to do extensive data transfers across the computer network and expedites access to the file for the local user. Although these local caching systems can work well, they suffer from the frailty that changes made to the original, or reference, file are not reflected in the locally cached copy. As such caching systems require mechanisms by which they can check if the reference file has been modified, and adjust how they service a local request for file based on this determination.

One technique for checking if a reference file has been modified, is to generate metadata that uniquely identifies the state of the reference file. Typically a hashing algorithm is run over the reference file to generate a unique identifier representing the present state of that data file. This metadata is usually a relatively small data file that can be readily transferred over a network. When a local node requests access to a remote file that is cached locally, the storage operating system can first request from the remote node storing the reference file, a copy of the metadata associated with that reference file. The remote node can return to the local node the metadata, and the local node can check whether the metadata for the reference file matches the metadata currently stored with the local cache copy. If the two are the same, the local node retrieves the data file from the local cache. If the returned metadata differs from the locally cached metadata, the storage operating system recognizes that the local cache is out of synchronization with the reference file, and deletes the local cache and requests the reference data file to be transferred to the local node.

One example of a cache system that uses hashing, is the BranchCache™ feature of Windows 7™ developed by Microsoft Corp. The BranchCache™ feature of Windows 7™ will cache content requested from a remote file server or web server at a local node or local network, depending on the circumstances. Subsequent requests from the local node or network for the file will be serviced by first providing content metadata. The content metadata is used to verify the local cache copy, and the Windows 7™ system uses the verification result to determine whether it can use the local cache copy or whether it must direct the remote file server to deliver the new content.

Although these caching systems can work well, the creation of metadata through application of a hash function can create a computational burden on the file server or network appliance that is responsible for generating the content metadata. This is particularly true for files which are large and often modified. These files are subject to repeated hashing operations, which can place a computational burden on the file server or appliance. These operations are required to keep the metadata up-to-date with the data.

Accordingly, there is a need for improved systems and methods for locally caching content on a network file system.

### SUMMARY OF THE INVENTION

The systems and methods described herein provide, among other things, storage systems that employ local file caching processes that generate state variables that record, for subsequent use, intermediate states of a file hash process. To this end, the systems and methods described herein essentially interrupt the hash process as it processes the data blocks of a file, and stores the current product of the interrupted hash process as a state variable that represents the hash value generated from the data blocks processed prior to the interruption. After interruption, the hash process continues processing the file data blocks. The stored state variables may be organized into a table that associates the state variables with the range of data blocks that were processed to generate the respective state variable.

Consequently, the systems and methods described herein, in certain embodiments, record the computational output of a one-way hash function after having processed an initial portion of the file being hashed, but prior to the entire file being processed. It is a realization of the invention, that typically, one-way hash functions generate a unique fixed length output for each unique binary string entered as input to the one-way hash. It is a further realization that each data file can be viewed as a collection of numbered data blocks that can be sequentially submitted to the hash process in the form of a binary string. As such, an intermediate computational value, along with a record of the offset of the file last processed to generate this intermediate value, represents a hashing process state variable. This state variable records the intermediate state of the hashing process and can be used as the starting value of a subsequent hashing operation run over later portions of the file. Consequently, modifications to the file that effect later sections of the file and leave the initial portion unchanged do not alter the accuracy of the intermediate computational value made over the initial portion of the file. Therefore re-computation of the hash value for the unaltered range of data blocks is unnecessary. A subsequent hashing of the modified file can use the state variable for the unaltered range as a starting point for a hash operation that will be run over the remaining portions of the file.

More particularly, the systems and methods described herein include methods for transferring data over a computer network, comprising the steps of storing a data file of the type that can be transferred over a computer network, and processing the stored data file to generate content metadata. The processing may include identifying data blocks within the data file, grouping the data blocks into one or more segments, starting at an initial block within the data file, running a one-way hash function over incrementing groups of data blocks to generate respective intermediate state hash values, and recording each respective state hash value and the associated data blocks hashed for that state hash value to create a table of state variables recording intermediate states of the hash operation performed over the data file. Additionally, the method may generate from the recorded state hash values, content metadata that is representative of a unique identifier for the data file. The method may transfer the content metadata in response to receiving a request to transfer the data file over the computer network.

Optionally, the method may also comprise detecting a file write of file append operation, determining an offset into the data file of the data block receiving data and identifying the state hash value associated with the revised data block, selecting the state hash value preceding the identified state hash value and computing a new state hash value from the preceding state hash value and data blocks having an offset greater than the data blocks associated with the preceding state hash value.

Additionally, the systems and methods may include systems for managing data stored on a computer network. These systems may include data storage for storing a data file; and a hash processor. The hash processor may select data blocks from within the data file, group the data blocks into one or more segments, starting at an initial block within the data file, run a one-way hash function over incrementing groups of data blocks within the segment to generate intermediate state hash values, and generate a state hash variable table to record the intermediate state hash values and associated data blocks hashed for that state hash value. The processor may also generate content metadata as a function of the state hash values to be representative of the data file.

### BRIEF DESCRIPTION OF THE DRAWINGS

The systems and methods described herein are set forth in the appended claims. However, for purpose of explanation, several embodiments are set forth in the following figures.

FIGS. 1A and 1B are schematic block diagrams of exemplary storage system environments in which some embodiments operate;

FIG. 2 is a more detailed schematic block diagram of an exemplary storage system;

FIG. 3 is a schematic block diagram of a file system generating a state hash variable table;

FIG. 4 is a pictorial representation of one exemplary state hash variable table;

FIG. 5 is a pictorial representation of a process for revising a state hash variable table;

FIG. 6 is a pictorial representation of an alternative state hash variable table;

FIG. 7 is a flow chart diagram of a process for generating a state hash variable table; and

FIG. 8 is a flow chart diagram of an alternate process for generating a state hash variable table.

### DETAILED DESCRIPTION

In the following description, numerous details are set forth for the purpose of explanation. To that end, certain exemplary systems and methods will be described, including storage systems that employ local file caching processes and that generate state variables to record, for subsequent use, intermediate states of a file hash process. In certain specific examples, there are systems that interrupt a hash process as it processes the data blocks of a file, and stores the current product of the interrupted hash process as a state variable that represents the hash value generated from the data blocks processed prior to the interruption. After the interruption, the hash process continues processing the file data blocks. The stored state variables may be organized into a table that associates the state variables with the range of data blocks that were processed to generate the respective state variable. Such exemplary systems can be used with any type of storage system, including file servers, database systems or other storage applications. Additionally, the systems and methods described herein are understood to reduce computational burden and improve network utilization, and as such the systems and methods described herein may be employed in applications that seek to reduce the computational resources needed for processing data or to reduce network traffic. Still other applications of the systems and methods described herein will be apparent to those of skill in the art, and any such application or use shall be understood to fall within the scope of the invention.

Moreover, one of ordinary skill in the art will realize that the embodiments described herein may be practiced without the use of the specific details set out in the exemplary embodiments and that in other instances, well-known structures and devices are shown in block diagram form to not obscure the description with unnecessary detail.

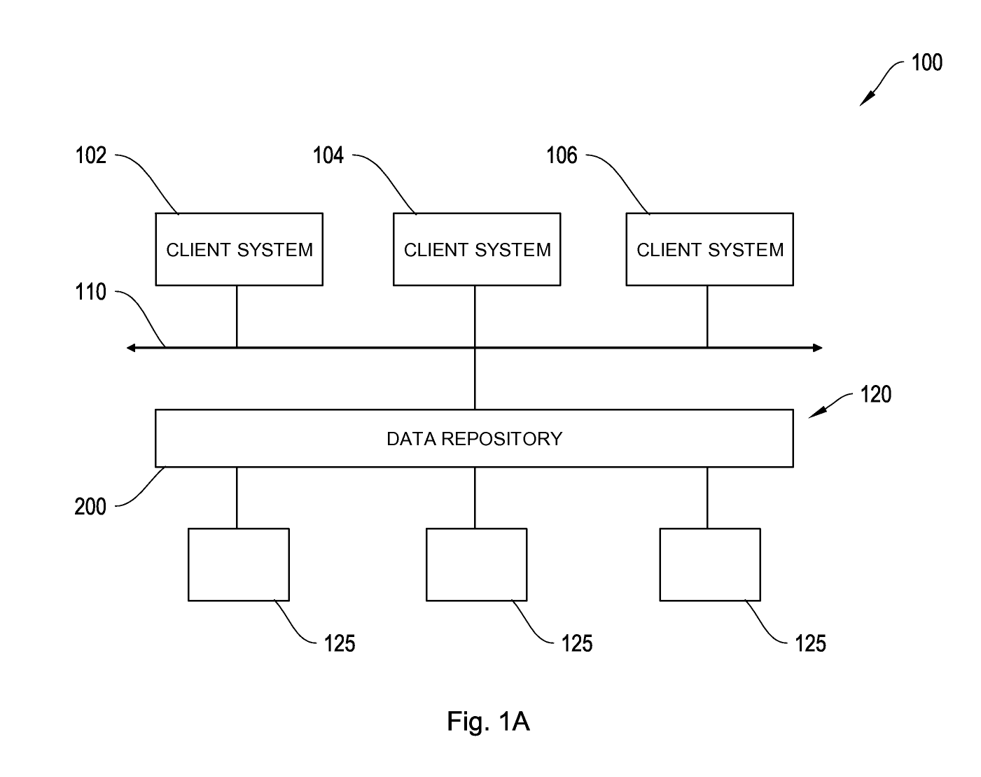

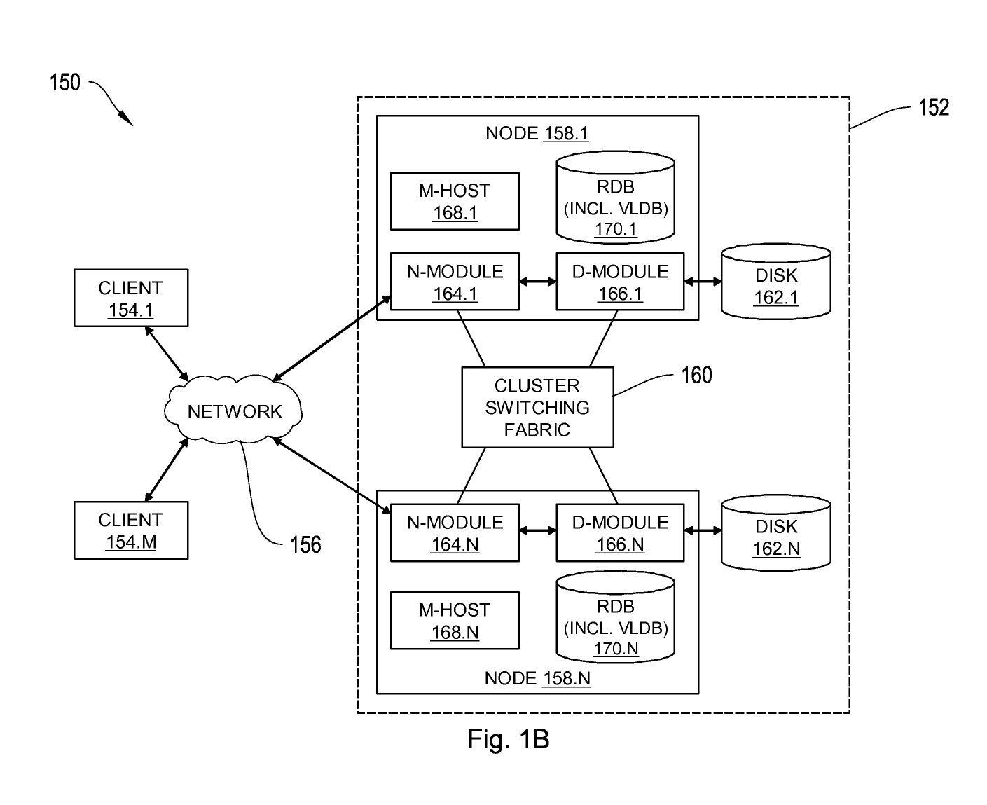

FIG. 1A is a schematic block diagram of an exemplary storage system environment 100 in which some embodiments of the systems and method described herein operate. The environment 100 has one or more client systems 102-106 and a storage system 120 (having one or more storage devices 125) that are connected via a connection system 110. The connection system 110 may be a network, such as a Local Area Network (LAN), Wide Area Network (WAN), metropolitan area network (MAN), the Internet, or any other type of network or communication system suitable for transferring information between computer systems.

A client system 102-106 may have a computer system that employs services of the storage system 120 to store and manage data in the storage devices 125. Client systems 102-106 may execute one or more applications that submit read/write requests for reading/writing data on the storage devices 125. Interaction between a client system 102-106 and the storage system 120 can enable the provision of storage services. That is, client systems 102-106 may request the services of the storage system 120 (e.g., through read or write requests), and the storage system 120 may perform the requests and return the results of the services requested by the server system 110, by exchanging packets over the connection system 110. The client systems 102-106 may issue access requests (e.g., read or write requests) by issuing packets using file-based access protocols, such as the Common Internet File System (CIFS) protocol or Network File System (NFS) protocol, over the Transmission Control Protocol/Internet Protocol (TCP/IP) when accessing data in the form of files and directories. Alternatively, the client systems 102-106 may issue access requests by issuing packets, possibly using block-based access protocols, such as the Fibre Channel Protocol (FCP), or Internet Small Computer System Interface (iSCSI) Storage Area Network (SAN) access, when accessing data in the form of blocks.

The storage system 120 may store data in one or more storage devices 125. A storage device 125 may be any suitable storage device and typically is a writable storage device media, such as disk devices, solid state storage devices (e.g., flash memory), video tape, optical, DVD, magnetic tape, and any other similar media adapted to store information (including data and parity information). The depicted storage devices 125 can be real or virtual and those of skill in the art will understand that any suitable type of storage device can be employed with the systems and methods described herein, and that the type used will depend, at least in part, on the application being addressed and the practical constraints of the application, such as equipment availability, costs and other typical factors.

The storage system 120 may implement a file system that logically organizes the data as a hierarchical structure of storage objects such as directories and files on each storage device 125. Each file may be associated with a set of storage (e.g., disk) blocks configured to store data, whereas each directory may be a specially-formatted file in which information about other files and directories are stored. A disk block of a file is typically a fixed-sized amount of data that comprises the smallest amount of storage space that may be accessed (read or written) on a storage device 125. The block may vary widely in data size (e.g., 1 byte, 4-kilobytes (KB), 8 KB, etc.). In some embodiments, the file system organizes file data by using data structures, such as but not being limited to, index node data structures (sometimes referred to as buffer trees), to represent the files in the file system. In any case, FIG. 1A shows that the systems and methods described herein typically work with storage systems that store data, usually in files, over a plurality of network devices, including nodes, servers and appliances, and will transfer data from one point on the network to another, depending upon the request made for the data and the location at which the data is stored.

FIG. 1B depicts a network data storage environment, which can represent a more detailed view of the environment in FIG. 1A. The environment 150 includes a plurality of client systems 154 (154.1-154.M), a clustered storage server system 152, and a computer network 156 connecting the client systems 154 and the clustered storage server system 152. As shown in FIG. 1B, the clustered storage server system 152 includes a plurality of server nodes 158 (158.1-158.N), a cluster switching fabric 160, and a plurality of mass storage devices 162 (162.1-162.N), which can be disks, as henceforth assumed here to facilitate description. Alternatively, some or all of the mass storage devices 162 can be other types of storage, such as flash memory, SSDs, tape storage, etc.

Each of the nodes 158 is configured to include several modules, including an N-module 164, a D-module 166, and an M-host 168 (each of which may be implemented by using a separate software module) and an instance of, for example, a replicated database (RDB) 170. Specifically, node 158.1 includes an N-module 164.1, a D-module 166.1, and an M-host 168.1; node 158.N includes an N-module 164.N, a D-module 166.N, and an M-host 168.N; and so forth. The N-modules 164.1-164.M include functionality that enables nodes 158.1-158.N, respectively, to connect to one or more of the client systems 154 over the network 156, while the D-modules 166.1-166.N provide access to the data stored on the disks 162.1-162.N, respectively. The M-hosts 168 provide management functions for the clustered storage server system 152. Accordingly, each of the server nodes 158 in the clustered storage server arrangement provides the functionality of a storage server.

FIG. 1B illustrates that the RDB 170 is a database that is replicated throughout the cluster, i.e., each node 158 includes an instance of the RDB 170. The various instances of the RDB 170 are updated regularly to bring them into synchronization with each other. The RDB 170 provides cluster-wide storage of various information used by all of the nodes 158, including a volume location database (VLDB) (not shown). The VLDB is a database that indicates the location within the cluster of each volume in the cluster (i.e., the owning D-module 166 for each volume) and is used by the N-modules 164 to identify the appropriate D-module 166 for any given volume to which access is requested.

The nodes 158 are interconnected by a cluster switching fabric 160, which can be embodied as a Gigabit Ethernet switch, for example. The N-modules 164 and D-modules 166 cooperate to provide a highly-scalable, distributed storage system architecture of a clustered computing environment implementing exemplary embodiments of the present invention. Note that while there is shown an equal number of N-modules and D-modules in FIG. 1B, there may be differing numbers of N-modules and/or D-modules in accordance with various embodiments of the technique described here. For example, there need not be a one-to-one correspondence between the N-modules and D-modules. As such, the description of a node 158 comprising one N-module and one D-module should be understood to be illustrative only. Further, it will be understood that the client systems 154 (154.1-154.M) can also act as nodes and include data memory for storing some or all of the data set being maintained by the storage system.

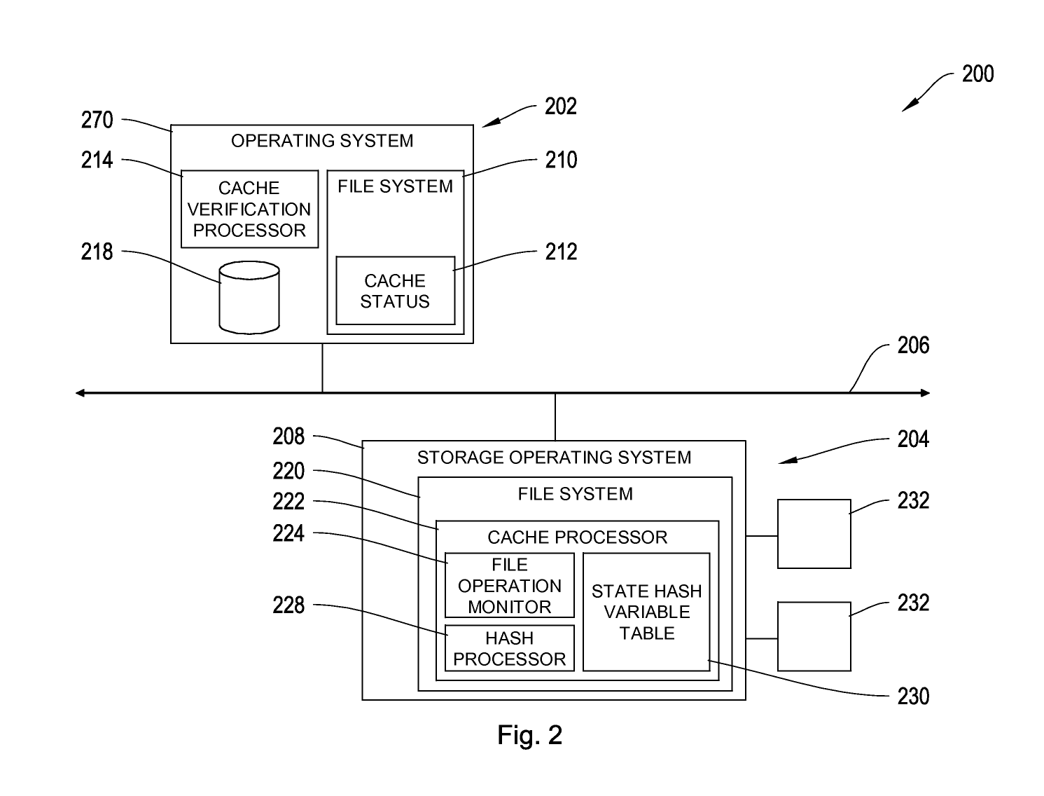

FIG. 2 illustrates in more detail a system that has a client, such as the client 102 depicted in FIG. 1A, that uses local cache storage to reduce the number of times data maintained by a storage system, such as storage system 120, is downloaded from the storage system to the client. More particularly, FIG. 2 presents a schematic block diagram of a storage system 200 environment that includes one client system 202, and shows in more detail one embodiment of a local cache storage system employed by the client system 202 to store cache copies of data, data files or other storage objects, that are maintained on a storage system 204. The depicted storage system 204, which may implement the functions of the storage system 120 depicted in FIG. 1A, includes one embodiment of a cache processor for managing data that is stored on the storage system 204 and that is also stored in at least one cache memory that is remote from the storage system 204. In particular, FIG. 2 depicts a storage system 200 that includes the client 202 having an operating system 270, a file system 210, a cache status table 212, a cache verification processor 214 and a local cache memory 218. FIG. 2 further depicts that the storage system 204 includes a storage operating system 208, a file system 220, a cache processor 222, a file operation monitor 224, a hash processor 228 and a state hash variable table 230. FIG. 2 further depicts that the storage system 204 is in communication with a plurality of storage devices 232.

The client system 202 has an operating system 270 that can respond to requests from application programs to read/write a file or other storage object and optionally cache a copy of that storage object. The operating system 270 can be any suitable operating system capable of storing data in files or other storage objects that can be distributed across the network depicted in FIG. 2. One such operating system 270 is Microsoft Windows 7. In one embodiment, the operating system 270 can receive requests for files stored within the file system 210. Such file systems are capable of identifying the location of a file stored across the network. Some files may be local, other files may be remote. The file system 210 implements protocols including CIFS, NFS, or any other suitable protocol that allow for requesting files over a computer network to retrieve files from a remote server.

The file system 210 in the depicted embodiment includes a file caching process that allows the file system 210 to store local copies of data files within the cache memory 218. To this end, the file system 210 can include a cache status table 212. The cache status table 212 can be a data file maintained by the file system 210 and containing information representative of locally cached data files that are copies of reference files stored remotely from the client 202. These remote files, the reference files, represent the actual file used by the storage operating system 208. As discussed above, the operating system 270 can create local cache copies of certain reference files. Such cache copies may be stored within the cache memory 218 depicted in FIG. 2. The depicted cache status table 212 can include metadata representative of those reference data files that have local cache copies stored within cache memory 218. In this way, the operating system 270 can service requests for a particular, remotely stored reference file by cross-referencing the requested remotely stored reference file against the cache files recorded within the cache status table 212 and maintained within the local cache memory 218.

FIG. 2 further depicts that the storage system 204 includes a storage operating system 208 that can access the server file system 220. The storage operating system 208 can be any suitable operating system capable of storing data in files or other storage objects that can be distributed across the network depicted in FIG. 2. One such storage operating system 208 is the Data ONTAP® storage operating system sold by the assignee hereof. In one embodiment, the storage operating system 208 can receive requests for files stored within the server file system 220, and the sever file system 220 can be any suitable file system, including the Write Anywhere File Layout (WAFL) available by NetApp, Inc. The server file system 220 includes a cache processor 222 that has a file operation monitor process 224, a hash processor 228 and a state hash variable table 230. The depicted cache processor 222 processes requests to deliver a reference file maintained by file system 220 to a remote location by determining whether the reference file should be downloaded or whether content metadata should first be transferred to the requesting client, such as the client 202.

When the file system 220 receives a request to download a reference file, the cache processor 222 can first check whether the reference file requested is the type of file that should be considered for local caching at client cites. Any suitable technique may be employed to determine which files are to be considered for local cache storage. In one practice, it may be administratively determined. For example, when the storage administrator shares a directory over CIFS, he can say whether the admin wants it to be shared with peers via hashes.

The cache processor 222, upon determining that the requested reference file should be locally stored in cache memory of the client, generates content metadata for the requested reference file. To that end, the hash processor 228 runs a hash process over the data blocks of the requested reference file. The hash process generates content metadata that represents a unique identifier for the reference data file. In a typical embodiment, the identifiers are generated by a hash algorithm that provides a sufficiently high probability of not repeating an identifier for two different files that the identifiers may be treated as unique, and mathematically certain uniqueness is not required by the systems and methods described herein. The file system 220 can return to the client 202 requesting the reference data file, both the content of the data file and the generated metadata. The client 202 can store the downloaded content of the reference file in the local cache 218 and record within the cache status table 212 the file name for the reference file and the content metadata generated for that reference file by the cache processor 222.

When the file system 210 receives a subsequent request for the reference data file, the file system 210 recognizes, typically by review of the file path data within the data file name, the request for a remote reference file and checks the cache status table 212 to determine whether the requested reference data file is stored within local cache 218. If the reference file is locally cached, the file system 210 issues a request for the reference file to the remote storage system 204. The file system 220 of storage system 204 receives the request and identifies, for that reference file, the content metadata that had been previously generated for that file. The storage system 204 answers the request from the client 202 by delivering the content metadata to the client 202. The client 202 receives the content metadata from Storage System 204 and compares the content metadata received from the storage system 204 against the content metadata stored within the cache status table 212 for the respective reference data file. A match between the content metadata indicates that the locally stored copy of the reference file is accurate and synchronized with the remotely stored reference file on storage system 204. As such the client file system 210 can service the request for the reference file by accessing and delivering the local cache copy stored with the memory 218. In contrast, a failure to match the content metadata received from the storage system 204 with content metadata stored in the cache status table 212 indicates that the reference file and local cache copy are no longer synchronized. The file system 210 then issues a request to receive file content for the reference file from the server 204 and the content of the reference file is downloaded from the storage system 204 to the client 202. Optionally, the local cache copy that is now out of synchronization is deleted from the local cache memory 218 as is the entry in the cache status table 212. Further optionally, the storage system 204 may deliver new content metadata associated with the reference file content being downloaded to the client 202, and the client 202 can make the necessary update to its local cache memory 281 and the cache status table 212. Further optionally, the metadata may be employed by the client 202 to determine if a different client on the network has a synchronized copy of the reference file and the client 202 may access the copy maintained by that other client.

In the event that an application, running on a client system 202 on the computer network 206, asks file system 210 to retrieve a file that is currently cached in another client system on network 206, the application may request the content metadata for the file from the server storage system 204. Upon receipt of the content metadata, the client 202 may broadcast the content metadata to other clients on the network 206. The other clients in receipt of the broadcast may include a client that has the file of interest cached in its local cache memory 218. The client in possession of the file may choose to share the file with the requesting client system 202 over the computer network 206, and using a communication protocol that may include, among others, HTTP. Upon receipt, by client system 202, of the requested file, the client system 202 may choose to verify that the file is synchronized with the file server 204, by comparing the content metadata received from the storage system 204 against the content metadata stored within the cache status table 212 for the respective reference data file. A match between the content metadata indicates that the locally stored copy of the reference file is accurate and synchronized with the remotely stored reference file on storage system 204.

In the systems and methods described herein, the cache processor 222 performs a hash process that incrementally hashes the data blocks of the reference file and generates during the incremental hash procedure one or more state variable hash values that are associated with the data blocks processed with the hashing algorithm to create that state variable hash value. Additionally, as shown in FIG. 2, the cache processor 222 organizes the state variable hash values into a table 230.

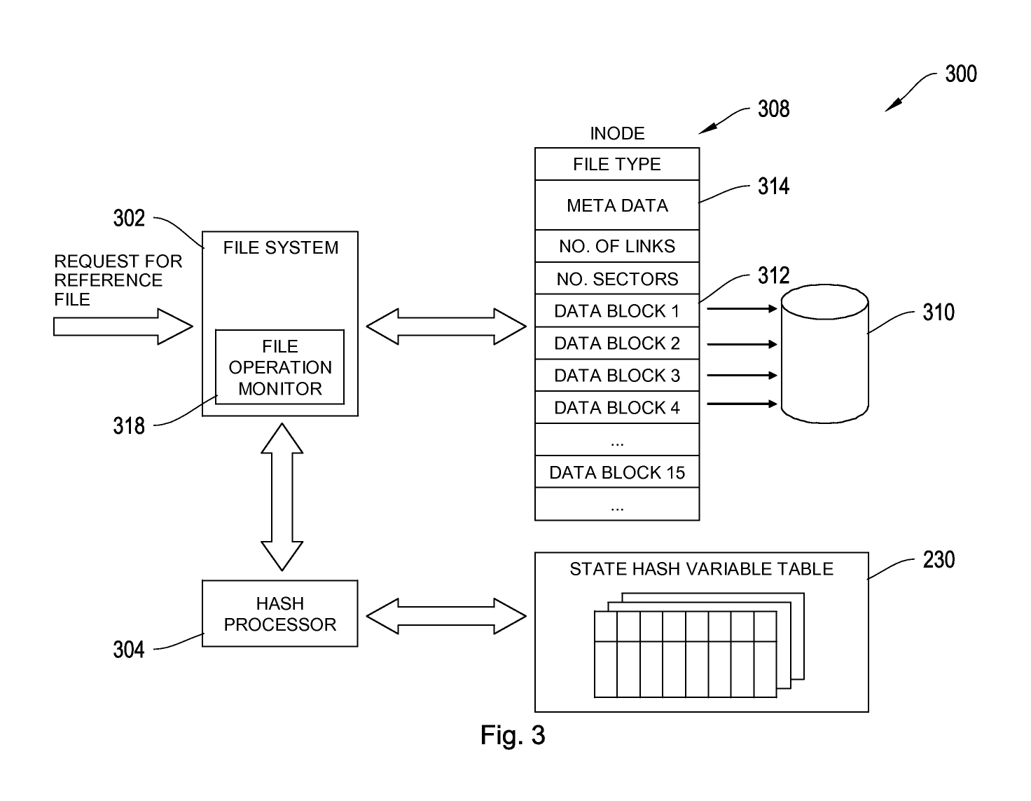

FIG. 3 represents the process 300 employed by the cache processor 222 to incrementally hash a reference file and create a table for the state hash variable table 230. Specifically, FIG. 3 depicts pictorially a process 300 that uses a file system 302 to access a reference file having an associated data structure, depicted as the index node data structure 308. FIG. 3 further depicts a storage device 310, a hash processor 304 and the state hash variable table 230. As pictorially represented in FIG. 3, the state hash variable table 230 may include a plurality of table entries. Typically, each table entry is associated with a single reference file. As a file server can have a plurality of reference files that are commonly called upon by remote clients, the state hash variable table 230 can include a plurality of table entries with each table entry being associated with a respective one of the plural reference files. In the depicted embodiment, each of the tables in the state hash variable table 230 is generated by hash processor 304. Hash processor 304 operates on data blocks provided by file system 302. File system 302 receives data blocks for the reference file by accessing the index node 308, also known as an i-node 308, associated with that reference file. As depicted in FIG. 3, the index node 308 includes a plurality of data block pointers 312. Data block pointers 312 may include indirect pointers which point to other indirect pointers or direct pointers, wherein direct pointers point to a storage location on a primary storage device, which is depicted in FIG. 3 as a hard disk system. The data block pointers 312 point to the physical storage locations of the data in the data blocks 312. In any case, the hash processor 304 is able to access the data blocks associated with the respective data file, or other storage object.

In operation, the file system 302 accesses the reference file when a request for the reference file is received from a node that is requesting transfer over a computer network such as the computer network 206 depicted in FIG. 2. Upon receipt of the request, the file system 302 can first access the state hash variable table 230 to determine whether the state hash variable table 230 contains a table associated with the requested reference file. In one practice, an entry within the state hash variable table 230 for a reference file indicates to the file system 302 that the reference file has been downloaded to at least one node on the network. As such, the file system 302 first collects the metadata from the state hash variable table 230 associated with the reference file and delivers that metadata to the storage operating system to deliver to the requesting client node. This may be achieved by the storage system 204 using a message generator that responds to the request by generating a data package that may be transferred over the network 206 to deliver the client the content metadata of the data file requested. As described above, the client node can compare the downloaded content metadata against any stored content metadata maintained in, for example, a cache status table 212 of FIG. 2. As further noted above, if the content metadata received matches the stored metadata, then the client node can select the locally cached copy of the reference file for use. If, however, the content metadata received differs from the stored content metadata within the cache status table 212, the client node recognizes that the reference file and local cache copy are no longer synchronized. Lack of synchronization between the local cache copy and the reference file typically arises due to editing or deletion of the reference file, which may occur in the normal course of using the reference file.

For example, during the normal course of use, the reference file might be edited such that data within the data blocks 312 are changed and a new version of the reference file is formed. The file operation monitor 312 detects the file operations that edit data blocks of the reference file index node 308. The file operation monitor 318 can direct the file system 302 to purge from the state hash variable table 230 that table entry associated with the edited reference file index node 308. The purged entry is replaced with a new entry that includes content metadata associated with the new version of the reference file. As computing the hash values of the reference file can be computationally intensive, the systems and methods described herein use an incremental hash process that generates state variables representative of intermediate stages of the hash process. These intermediate stages capture the state of the hashing function at an incremental point through the data blocks of the index node, such as the i-node 308. Typically the hashing process uses a one way hash algorithm that uses a block processing algorithm that will process a input stream of text blocks having an arbitrary length to generate a fixed length hash value, H, that is uniquely associated with the input blocks applied to the one way hash algorithm. As such, intermediate values of the returned fixed length hash value H capture the unique hash value representation of the data blocks processed, and the hash of the last block becomes the hash of the entire message.

The hashing process may be computationally intensive. Typically the hash algorithm, such as the MD4, MD5, SHA256, SHA512 or other algorithm, organizing the data blocks of the file into a series of blocks, each block being of the same length with padding employed to fill blocks. The blocks are then processed in a loop that uses different blocks in the message as operands within different logical operations, typically operations like exclusive OR functions. In any case, the output of the operation is a unique fixed length message that essentially only can be generated by applying the specific binary code of the input data blocks to the one way hash algorithm.

The systems and methods described herein capture the output of the hash algorithm at different points within the hashing process of the reference file. In particular, as the file system 302 collects data blocks 312 from the reference file index node 308, the file system 302 makes a record of the index node data blocks 312 that are being applied to the one way algorithm. After a certain portion of the data blocks 312 that make up the reference file index node 308 are applied to the hash processor 304, the file system 302 records the intermediate hash value and the data blocks 312 associated with that intermediate hash value. This recorded data is stored within the state has variable table 230 for subsequent use.

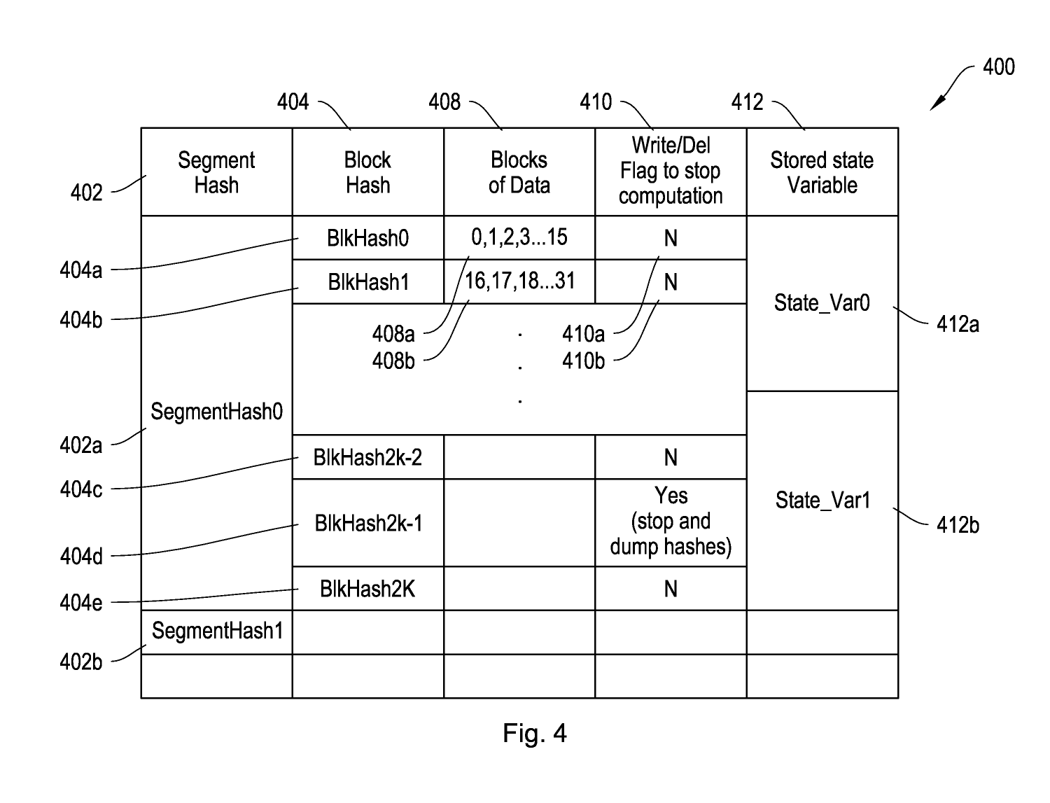

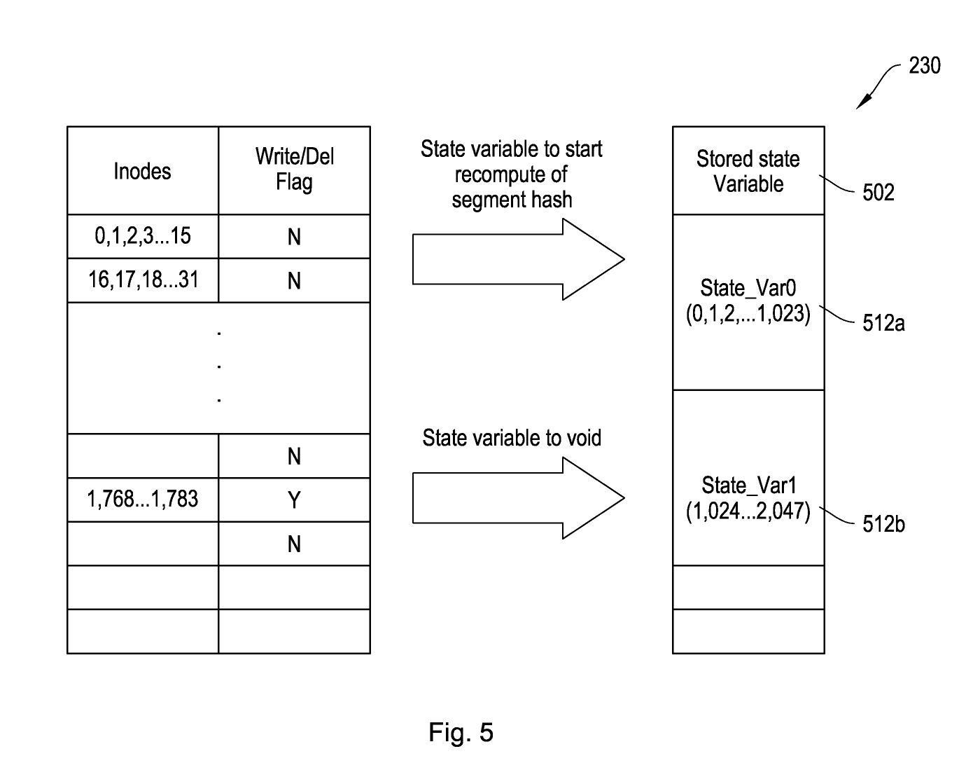

FIGS. 4 and 5 depict in more detail and for one particular practice and embodiment, a state variable hash table constructed for use with the systems and methods described herein. In particular, FIG. 4 depicts an example of the data for one type of state hash variable table 230. In particular, FIG. 4 depicts a table 400 that includes a first column 402, which includes segment hashes 402A and 402B, a column 404 that includes block hash data, a column 408 that includes data block reference numbers, a column 410 that includes/delete flags and a column 412 for stored state variables.

The state hash variable table 400 depicted in FIG. 4 will be explained for purpose of illustration as being employed with the hash algorithm used in the BranchCache™ process of Window 7™. This exemplary hash process has two steps. First, the data blocks of the reference file are grouped together into 64K blocks, and then hashed using the SHA one-way hash function. In a second step, the process collects the block hashes into segments of 32 MB, and then hashes the segments, also using the SHA one-way hash. The segment hashes are used as the content metadata for the reference file. This process is illustrated by FIG. 4, which shows the data blocks of the reference file being grouped into 64K blocks and the block hashes being grouped into 32 MB segments. In this hash process, in response to a client requesting a file from the content server, the content server returns the segment hashes built from the block hashes.

In this practice, each block hash is made up from a 64K block of data from the reference data file. That 64K block of data can be mapped by the file system 302 to a set of data blocks 312 of the reference data file index node 308. Each 64K block can map to sixteen 4K or eight 8K data blocks in the file. As the file system 302 includes a pointer to the index node associated with the reference file, the file can increment the pointer to increase the offset into the index node and get the data blocks 312 in incrementing order. The file system 302 can map a block of data 312 to a computed block hash, such as block hash 404a.

In one practice the block hash, such as the depicted block hash 404A is computed from the blocks of data 0 through 15 representing the first sixteen blocks of data in the reference file index node 308. In this embodiment each data block 312 includes 4K of data, and the sixteen data blocks in total hold 64K of data. The 64K of data are provided to the hash processor 304 to generate a fixed length block hash 404A. As illustrated by column 408, the hash processor 304 can pull data blocks 312 from the reference file index node 308 until all data blocks have been organized into 64K blocks, and each 64K block is processed by the hash algorithm to generate a respective block hash value such as block hash 404A or block hash 404B.

As further illustrated by FIG. 4, the exemplary BranchCache™ process selects a plurality of block hash values until a segment of 32 MB are collected. The 32 MB of block hashes are hashed by the hash processor 304 to generate a segment hash, such as the segment hash 402A depicted in FIG. 4. The exemplary BranchCache™ process continues to group block hashes into 32 MB sections, with segment hashes being generated for each 32 MB segment until all block hashes of the reference file have been processed. The segment hash values 402A, 402B et seq. can be used by the caching system as content metadata that can be provided by the storage system to the remote client.

FIG. 4 further depicts a column 412 that organizes a set of stored state variable values. As depicted schematically in FIG. 4, each segment hash includes two state variables, such as state variables 412A and 412B. Each state variable 412A and 412B represents the incremental hash value of the respective segment hash 402A as it processes through the first half of the block hashes and then the second half of the block hashes. As the one-way hash process takes in a file of arbitrary size and produces a unique fixed length output, H, it is a realization of the system and methods described herein that the hash value, H, generated by processing an initial portion of the data blocks of the reference file can act as a state variable that represents the state of the hashing process in producing the final hash, after having hashed a first set of the data blocks of the data file. This provides an intermediate value for the hash process, that can be stored and later used as a starting point for any subsequent hashing effort that does not require this first set of data blocks to be rehashed. FIG. 4 depicts this process for one segment. However, larger files with multiple segments can be processed in the same manner, with the state variable being stored, along optionally with segment hashes to provide state variable data for the hashing process to use if the reference file is charged and one or more segment hashes need to be recomputed.

As the file operation monitor 318 monitors file operations, including writes and deletes, the table 400 is updated in column 410 to indicate whether data blocks in the reference file index node 308 have been amended or deleted. The file system 302 can enter data into column 410 of table 400 to indicate, typically by setting a flag, the 64K data block that includes data blocks that have been either deleted or edited. In FIG. 4, the block hash 404D is derived from the blocks of data 408D, and Flag 410D indicates that at least one of the blocks of data in 408D has been either edited or deleted. As such, the block hash 404D derived from the data blocks 408D is now inaccurate. As indicated in the table at 410D, the deletion or editing of data blocks can result in the system dumping block hashes associated with the state variable 412B that is now no longer representative of the content of the reference file 308.

However, the state variable 412A is still associated with data blocks in column 408 that have not been edited or changed and therefore the state variable 412A can be retained. The new segment hash 402A can be generated from using state variable 412A and processing those data blocks 408C and higher, as those data blocks are associated with the discarded state variable 412B. It is understood that this process, reduces the computational burden of hashing the reference file 308 by avoiding the need to rehash blocks of data 408 that have remained unchanged between versions of the file.

FIG. 5 depicts the process of dumping block hashes associated with changed data and an example of a reduced data set that can be stored as a state hash variable table 230. Specifically, FIG. 5 depicts a table 230 having a single column 502. The column 502 stores state variables, 512a and 512b. Each state variable is associated with the block hashes used in one-half of a segment, thus in this example, 16 MB of block hash data. As the SHA one-way hash produces block hashes of fixed size, such as 512 bytes, and operation of data blocks of fixed size, the file system 302 can associate each state variable with a specific range of data blocks in the data file. FIG. 5 further illustrates that the systems and methods described herein work in part by incrementally processing the data blocks and saving the hash value generated at certain points in the process, such as half way through the data blocks processed for a segment. As such, if the file changes in such a way that only data blocks used for the second half of the segment are altered or deleted, then the state variable generated from data blocks used for the first half of the segment can be saved. If, however, the data blocks of the first half were to change then all state variable would be inaccurate and all block caches would need to be dumped and the segment hash recomputed from the original data blocks 312 of the file index node 308.

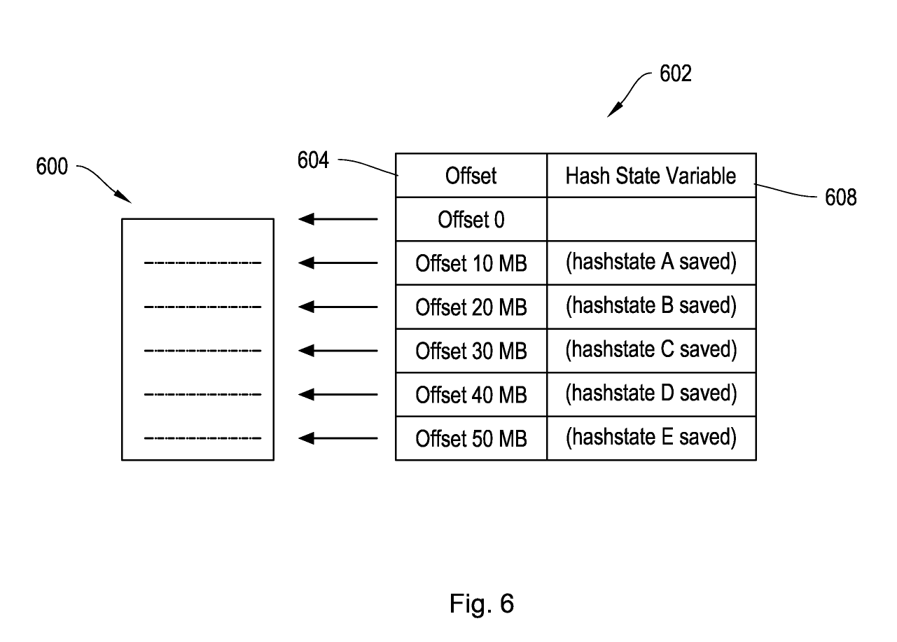

FIG. 6 depicts an alternative hashing process for use with the systems and methods described herein. FIG. 6 depicts pictorially a process for hashing a reference file 600 to generate a state hash variable table 602. In this embodiment, the client server system may be implementing an alternate process for local caching of reference files. In this practice, the hashing processor 304 can set to an arbitrary segment size, and typically will set the segment size to be the full length of the reference file. In the example shown in FIG. 6, the reference file 600 is approximately 50 MB. The hash processor 304 selects data blocks 312 from the reference index node 308 associated with the reference file 600. The data blocks 312 are provided to the hash processor 304 in descending order through the index node 308. As the offset ascends further into the index node, the hash processor 304 can, at 10 MB increments, store the hash state variable 608 associated with the respective incremental offset 604.

As described above with reference to the earlier embodiment, a hash state variable 608 can be retained as long as there is a continuous and unchanged set of data blocks running from the initial data block and passed the 10 MB offsets associated with a respective hash state variable of those 10 MB offsets. In this embodiment, the final hash value can be used as the content metadata that can be sent to the client system requesting the reference file 308.

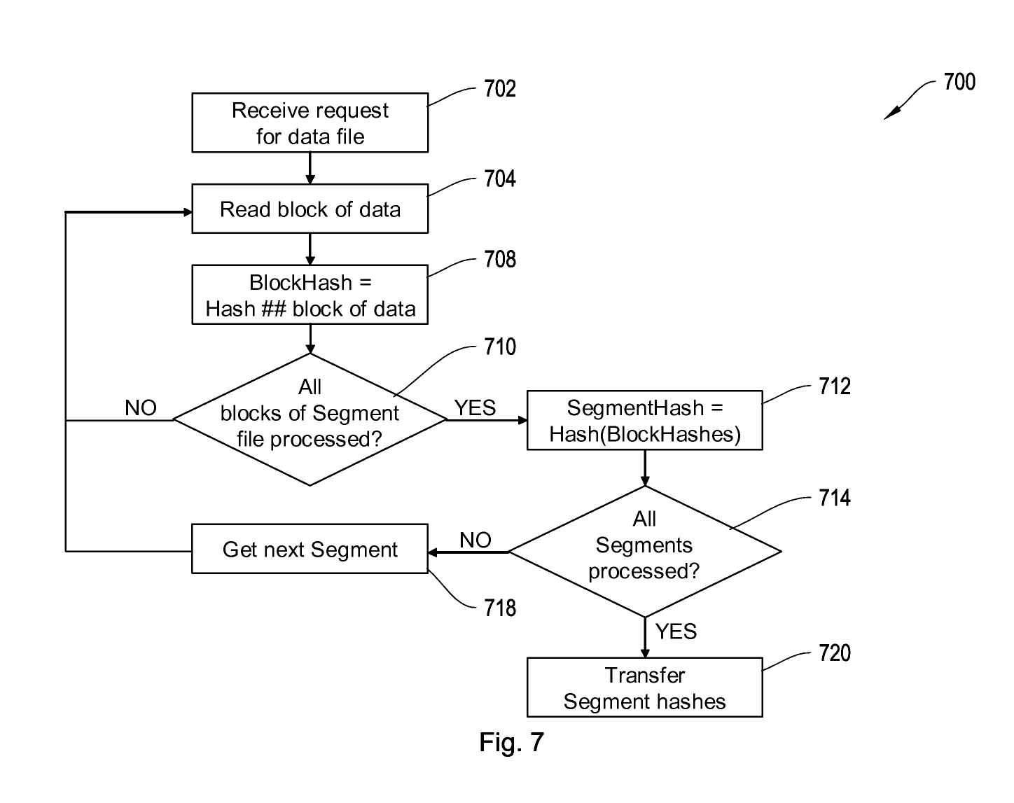

Having described certain embodiments, it will now be understood that the systems and methods described herein include certain processes including the process 700 depicted in FIG. 7. In particular, FIG. 700 depicts a process for performing a one-way hash of data blocks making up a file or other storage object, and generating from the hashed data blocks, metadata that can be transferred to a client node. The metadata may be employed by the client node to check whether a local cache copy of a reference file may be used to service a request for that file. In particular, the process 700 begins in a step 702 wherein a request for a particular reference file is received. The process 700 proceeds to step 704 wherein data blocks of that respective reference file are read. In step 708 the data block read from the file is hashed according to a one-way hash algorithm, such as the SHA, MD4, MD5, or some other suitable one-way hash algorithm. In step 708 a block hash value is generated from the data blocks read in step 704. In step 710 the process 700 makes an intermediate check of the file. In this process 700 the step 710 has organized blocks into sets of data that can generate 32 MB of block hash data. If step 710 determines that all the data blocks from the file being processed needed to perform a segment hash have been processed then the process 700 proceeds to step 712. In step 712 a segment hash is computed by running a one-way hash algorithm over the 32 MB of block hash data prepared. Alternatively, if all the blocks needed have not been processed then the process 710 precedes back to step 704. In step 704 additional data blocks are read for the file and block hashes in step 708 are created. As described above, the process 700 can record the data blocks of the file that are associated with each block hash being generated. In any case, the process 700 can continue through the process of reading data blocks from the file until all data blocks have been subject to a one-way hash process.

Returning to step 712, the segment hash may be generated by running the one-way hash across 32 MB of block hash data. In the process 700, the segment hash operation can be subdivided into two or more sections, and after each section the segment hash value as it currently exists can be recorded in a state hash variable table. The recorded state hash variable table can be associated with the data blocks of the file that were hashed to create the block hash data that comprises the section of the segment which has been subject to the segment hash process in step 712.

After step 712 the process 700 proceeds to step 714 wherein the process checks if all segments have been processed by the segment hash operation. If, as shown in FIG. 7, segments remain to be processed then the next segment can be collected and the process 700 can loop through the block hash and segment hash process described above. If however, all segments have been hashed then the process 700 proceeds to step 720 wherein the segment hashes are transferred to the node having made the request that was received in step 702.

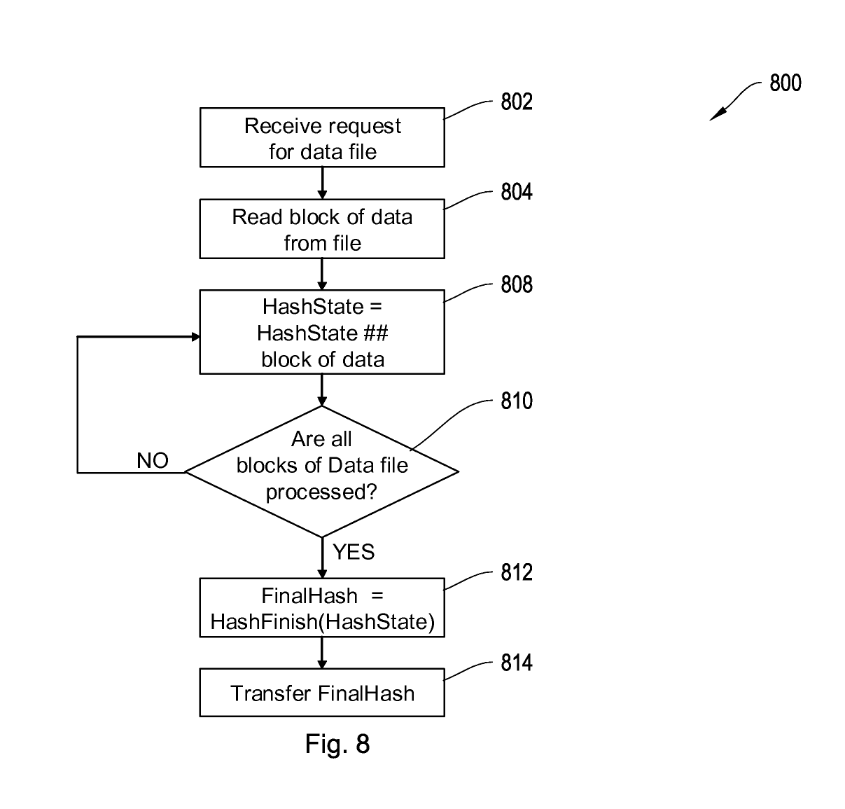

FIG. 8 depicts an alternative embodiment of a process for generating block hashes and state hash variable tables. In particular, the process 800 beings with the step 802 where it receives request for a datafile. In step 804 the process 800 reads a block of data from the file and passes that block of data to a hash operation which, in step 808, is applied to the block of data. Step 808 records a hash state representing the incremental hash state of the process being used to generate the content metadata for the particular requested file. As described above, the hash state data can be stored as a state variable. The process 800 can arbitrarily select different points for recording the hash state data and can record the data blocks that were processed to generate that hash state data. The process 800 includes a loop that includes step 810 and 808 which will cycle through all blocks of data within the file until all data blocks have been processed by the one-way hash function used to generate the content metadata. Once the loop is complete the process 800 can proceed to step 812 wherein a final hash value is generated. Once the final hash value is generated, the process 800 can proceed to step 814 wherein the final hash value is transferred to the node that requested the data file and that node can use the final hash value as a content metadata value which can be used to verify the correctness of a local cash copy of the requested file. The process employed to generate a final hash process may vary and typically will depend upon the hash process applied to the file. For example, in SHA256 the initial block is divided into pieces and the subsequent pieces are divided into the result as pieces. The final operation is essentially a concatenation of the intermediate state variables. In the case of SHA256, the process may use the final value as the state variable for an append operation. But with other hashing functions, such as SHA224, the final value omits the last hash variable. These and other hashing processes including processes for finishing the resulting hash, are known to those of skill in the art and some processes and examples include IETF Network Working Group Request For Comment, RFC 3874: A 224-bit One-way Hash Function: SHA-224, (ietf.org); and IETF Network Working Group Request For Comment, RFC 6234: U.S. Secure Hash Algorithms SHA and SHA-based HMAC and HKDF (ietf.org), which contains sample C implementations, the contents of which are incorporated by reference.

The software modules, software layers, or threads described herein may comprise firmware, software, hardware or any combination thereof and is configured to perform the processes described herein. For example, the storage operating system may comprise a storage operating system engine comprising firmware or software and hardware configured to perform embodiments described herein. As a further example, the hash processor 304 may have an engine which includes firmware or software and hardware configured to perform as described herein.

The storage devices 125 and 232 may comprise disk devices that are arranged into a plurality of volumes, each having an associated file system. In some embodiments, the storage devices 125 or 232 comprise disk devices that are configured into a plurality of RAID (redundant array of independent disks) groups whereby multiple storage devices 125 or 232 are combined into a single logical unit (i.e., RAID group). In a typical RAID group, storage devices 125 or 232 of the group share or replicate data among the disks which may increase data reliability or performance. The storage devices 125 or 232 of a RAID group are configured so that some disks store striped data and at least one disk stores separate parity for the data, in accordance with a preferred RAID-4 configuration. However, other configurations, for example RAID-5 having distributed parity across stripes, RAID-DP, etc., are also contemplated. A single volume typically comprises a plurality of storage devices 125 or 232 and may be embodied as a plurality of RAID groups.

FIG. 3 presents a conceptual diagram of an index node, or i-node, data structure (buffer tree) representing a file. The index node data structure 308 may comprise an internal representation of data blocks for a file loaded into the memory and maintained by the file system 302. An index node data structure 308 for a file may store information 314 about the respective file such as the file type, access rights, the owner of the file, the size of the file, the last time it was accessed, any groups it belongs to and other information. The bulk of the index node 308 is made up of data block pointers 312. The data block pointers 312 are separately numbered and, in the depicted embodiment, are sequentially numbered. The data block pointers 312 point to the physical location of disk blocks stored on the primary storage such as the storage devices 310. As such the index node 308 provides the file system 302 with an abstraction of a data file that includes a series of data block pointers 312 that point to the physical location of the data of the file.

Some embodiments of the above described may be conveniently implemented using a conventional general purpose or a specialized digital computer or microprocessor programmed according to the teachings herein, as will be apparent to those skilled in the computer art. Appropriate software coding may be prepared by programmers based on the teachings herein, as will be apparent to those skilled in the software art. Some embodiments may also be implemented by the preparation of application-specific integrated circuits or by interconnecting an appropriate network of conventional component circuits, as will be readily apparent to those skilled in the art. Those of skill in the art would understand that information and signals may be represented using any of a variety of different technologies and techniques. For example, data, instructions, requests, information, signals, bits, symbols, and chips that may be referenced throughout the above description may be represented by voltages, currents, electromagnetic waves, magnetic fields or particles, optical fields or particles, or any combination thereof.

Some embodiments include a computer program product comprising a computer readable medium (media) having instructions stored thereon/in and, when executed (e.g., by a processor), perform methods, techniques, or embodiments described herein, the computer readable medium comprising sets of instructions for performing various steps of the methods, techniques, or embodiments described herein. The computer readable medium may comprise a storage medium having instructions stored thereon/in which may be used to control, or cause, a computer to perform any of the processes of an embodiment. The storage medium may include, without limitation, any type of disk including floppy disks, mini disks (MDs), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any other type of media or device suitable for storing instructions and/or data thereon/in. Additionally, the storage medium may be a hybrid system that stored data across different types of media, such as flash media and disc media. Optionally, the different media may be organized into a hybrid storage aggregate. In some embodiments different media types may be prioritized over other media types, such as the flash media may be prioritized to store data or supply data ahead of hard disk storage media or different workloads may be supported by different media types, optionally based on characteristics of the respective workloads. Additionally, the system may be organized into modules and supported on blades configured to carry out the storage operations described herein.

Stored on any one of the computer readable medium (media), some embodiments include software instructions for controlling both the hardware of the general purpose or specialized computer or microprocessor, and for enabling the computer or microprocessor to interact with a human user and/or other mechanism using the results of an embodiment. Such software may include without limitation device drivers, operating systems, and user applications. Ultimately, such computer readable media further includes software instructions for performing embodiments described herein. Included in the programming (software) of the general-purpose/specialized computer or microprocessor are software modules for implementing some embodiments.

Those of skill would further appreciate that the various illustrative logical blocks, modules, circuits, techniques, or method steps of embodiments described herein may be implemented as electronic hardware, computer software, or combinations of both. To illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the embodiments described herein.

The various illustrative logical blocks, modules, and circuits described in connection with the embodiments disclosed herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The techniques or steps of a method described in connection with the embodiments disclosed herein may be embodied directly in hardware, in software executed by a processor, or in a combination of the two. In some embodiments, any software module, software layer, or thread described herein may comprise an engine comprising firmware or software and hardware configured to perform embodiments described herein. In general, functions of a software module or software layer described herein may be embodied directly in hardware, or embodied as software executed by a processor, or embodied as a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read data from, and write data to, the storage medium. In the alternative, the storage medium may be integral to the processor. The processor and the storage medium may reside in an ASIC. The ASIC may reside in a user device. In the alternative, the processor and the storage medium may reside as discrete components in a user device.

While the embodiments described herein have been described with reference to numerous specific details, one of ordinary skill in the art will recognize that the embodiments can be embodied in other specific forms without departing from the spirit of the embodiments. Thus, one of ordinary skill in the art would understand that the embodiments described herein are not to be limited by the foregoing illustrative details, but rather are to be defined by the appended claims.

1. A method for transferring data over a computer network, comprising:
storing a data file of the type that can be transferred over a computer network;
processing the stored data file to generate content metadata, the processing including:
identifying data blocks within the data file;
grouping the data blocks into one or more segments, starting at an initial block within the data file,
running a one-way hash function over incrementing groups of data blocks to generate respective intermediate state hash values; and
recording each respective state hash value and the associated data blocks hashed for that state hash value to create a table of state variables recording intermediate states of the hash operation performed over the data file; and
generating from the recorded state hash values content metadata representative of a unique identifier for the data file; and
transferring the content metadata in response to receiving a request to transfer the data file over the computer network.

2. The method of claim 1, further comprising:
detecting a file write operation writing data into a data block of the data file;
determining an offset into the data file of the data block receiving data and identifying the state hash value associated with the revised data block;
selecting the state hash value preceding the identified state hash value; and
computing a new state hash value from the preceding state hash value and data blocks having an offset greater than the data blocks associated with the preceding state hash value.

3. The method of claim 1, further comprising:
detecting a file append operation appending a data block to the data file; and
computing a new state hash value as a function of the state hash value preceding the last state hash value and as a function of the appended data block.

4. The method of claim 1, further comprising
generating a block hash representative of a hash of a data block.

5. The method of claim 4, further comprising
selecting a plurality of block hashes associated with a segment and hashing the block hashes to generate a segment hash.

6. The method according to claim 5, wherein the content metadata includes at least one segment hash.

7. The method of claim 1, wherein a final segment in a data file is processed according to a hash finish process.

8. The method of claim 1, further comprising
storing the table including the intermediate hash values in a data memory.

9. The method of claim 1, further comprising
in response to transferring the content meta data, receiving a request to transfer the data file, and transferring the data file.

10. The method of claim 1, further comprising
receiving and storing the content metadata within a local file cache on a remote client.

11. The method of claim 10, further comprising,
at the remote client, receiving a request for the data file, requesting the data file for transfer over the computer network and comparing the content metadata received over the computer network against content metadata stored in the local file cache to determine whether to service the request from the local file cache.

12. A system for managing data stored on a computer network, comprising:
data storage for storing a data file; and
a hash processor for
selecting data blocks from within the data file;
grouping the data blocks into one or more segments, starting at an initial block within the data file, and
running a one-way hash function over incrementing groups of data blocks within the segment to generate intermediate state hash values,
a state hash variable table having storage to record the intermediate state hash values and associated data blocks hashed for that state hash value.

13. The system of claim 12, further comprising:
a file monitoring process for detecting a file write operation writing data into a data block of the data file, and wherein the hash processor includes
a processor for determining an offset into the data file of the data block receiving data and identifying the state hash value associated with the revised data block;
a processor for selecting the state hash value preceding the identified state hash value; and
a processor for computing a new state hash value from the preceding state hash value and data blocks having an offset greater than the data blocks associated with the preceding state hash value.

14. The system of claim 12, further comprising:
a file monitoring process for detecting a file append operation appending a data block to the data file and for computing a new state hash value as a function of the state hash value preceding the last state hash value and as a function of the appended data block.

15. The system of claim 12, wherein the hash processor groups the data blocks into one segment having a size for including all data blocks of the data file.

16. The system of claim 12, wherein the hash processor includes a segment hash processor for processing content metadata generated from a hash operation of a group of data file data blocks.

17. The system of claim 12, wherein the hash processor includes a one-way processor including at least one of a SHA processor, an MD5 processor, or an MD4 processor.

18. The system of claim 12, wherein the hash processor includes a hash finish processor for processing a state hash value to generate content metadata.

19. The system of claim 12, further including a storage operating system having a message generator for responding to a request from a remote client for access to a data file by generating a data package for transfer over a computer network and carrying content metadata associated with the data file requested.

20. A method for storing data on a data network using local cache memories, comprising
providing a client having
a local cache for storing a copy of a reference data file stored on a remote server and
a cache verification processor for generating a request for content metadata to verify accuracy of the copy, and
providing a server for receiving the request for the content metadata and having a table of state variables recording intermediate states of a hash operation performed over data blocks of the reference data file, and
generating the requested content metadata as a function of a detected change to the stored reference data file and the table of state variables, and including
identifying an initial altered data block representative of a first occurrence of an altered data block within a sequence of data blocks making up the reference data file,
identifying a state variable preceding a state variable associated with the initial altered data block; and
computing a new state variable from the preceding state variable and data blocks occurring subsequent to data blocks associated with the preceding state variable,
generating the requested content metadata from the new state variable, and
at the client comparing the received content metadata against stored content metadata to verify the accuracy of the cache copy.
